(19) United States
(12) Patent Application Publication
(10) Pub. No.: US 2006/0132408 A1
(43) Pub. Date: Jun. 22, 2006

(54) Liquid crystal display and driving method of the same

(76) Inventors: Kyoung-ju Shin, Yongin-si (KR); Cheol-woo Park, Suwon-si (KR); Jae-jin Lyu, Gyeonggi-do (KR); Mee-hye Jung, Hwaseong-si (KR); Chong-chul Chai, Seoul (KR); Ho-yong Jung, Suwon-si (KR)

Correspondence Address: CANTOR COLBURN, LLP, 55 GRIFFIN ROAD SOUTH, BLOOMFIELD, CT, 06002, US

(21) Appl. No.: 11/311,064

(22) Filed: Dec. 19, 2005

(30) Foreign Application Priority Data
Dec. 20, 2004 (KR) 2004-108832

(51) Int. Cl. G09G 3/36

(52) U.S. Cl. 345/89

(57) ABSTRACT

The present invention relates to a liquid crystal display comprising a thin film transistor substrate formed with a gate line and a data line; first and second gray scale voltage generating parts generating a first and a second gray scale voltage, respectively; a data driving part receiving the first and second gray scale voltages, and applying a data voltage to a plurality of sub pixels formed by crossing of the gate line and the data line; and a signal controlling part controlling the data driving part to divide the plurality of sub pixels into first and second areas, and to apply the data voltage corresponding to a gray scale signal responsive to the first and second gray scale voltages to the first and second areas, respectively. Thus, the present invention provides an LCD enhancing visibility in the side view and a driving method of the same.

This application claims priority to Korean Patent Application No. 2004-108832, filed on Dec. 20, 2004 and all the benefits accruing therefrom under 35 U.S.C. § 119, and the contents of which in its entirety are herein incorporated by reference.

### BACKGROUND OF THE INVENTION

1. Field of the Invention

The present invention relates to a liquid crystal display and a driving method of the same, and more particularly, to a liquid crystal display and a driving method of the same dividing a plurality of sub-pixels into two areas and supplying different gray scale voltages to each area for visibility enhancement.

2. Description of the Related Art A liquid crystal display (“LCD”) comprises a liquid crystal display panel that includes a thin film transistor (“TFT”) substrate provided with a thin film transistor, a color filter substrate provided with a color filter layer, and a liquid crystal layer interposed between the TFT substrate and the color filter substrate. Since the liquid crystal display panel cannot emit light itself, a backlight unit may be located behind the TFT substrate to emit light. The light transmittance of the backlight unit through the liquid crystal display panel depends on the alignment of liquid crystal molecules within the liquid crystal layer.

The LCD features a thin and small appearance and has low-power consumption, however, it is not accommodating to large size applications, full color embodiments, contrast enhancement, wide viewing angle, etc.

To overcome the weak point of the LCD with respect to the viewing angle, there have been various technologies employed such as a multi-domain technology, a phase compensating technology, an in-plane switching (“IPS”) mode, a vertical alignment (“VA”) mode, a light propagation adjusting technology, etc. Furthermore, there have been developments of a patterned vertical alignment (“PVA”) mode, a surrounding electrode (“SE”) mode, a ridge and fringe field multidomain homeotropic (“RFFMH”) mode, a lateral field induced vertical alignment (“LFIVA”) mode, etc., which are respectively resultants from applications of other technologies such as a cholesteric dopant, a direction control electrode, a ridge, an aligning method using rubbing, etc. to a partially etched slit of a pixel electrode based on the multidomain technology in the VA mode.

The PVA mode, one version of the VA mode, has a pixel electrode and a common electrode each provided with an incision pattern. The PVA mode adjusts the direction of liquid crystal molecules within the liquid crystal layer by using a fringe field formed by the incision pattern, thereby widening the viewing angle.

In the PVA mode, the liquid crystal is vertically aligned, and there is a distinction of liquid crystal retardation between a front view and a side view. Thus, in the side view, a liquid crystal distortion may enlarge a gamma distortion, which may raise the brightness of low gray scale rapidly and result in the deterioration of visibility with the lowering of contrast ratio.

### BRIEF SUMMARY OF THE INVENTION

Accordingly, it is an aspect of the present invention to provide an LCD that enhances visibility in the side view and a driving method of the same.

Additional aspects and/or advantages of the present invention will be set forth in part in the description which follows and, in part, will be obvious from the description, or may be learned by practice of the present invention.

The foregoing and/or other aspects of the present invention are also achieved by providing a liquid crystal display including a thin film transistor substrate formed with a gate line arranged in a first extensional direction and a data line arranged in a second extensional direction; an insulating substrate opposite the thin film transistor substrate; a liquid crystal layer interposed between the thin film transistor substrate and the insulating substrate; a gray scale voltage generating part comprising a first gray scale voltage generating part generating a first gray scale voltage, and a second gray scale voltage generating part generating a second gray scale voltage; a data driving part receiving the first and second gray scale voltages from the gray scale voltage generating part, and applying a data voltage to a plurality of sub pixels formed by crossing of the gate line and the data line; and a signal controlling part controlling the data driving part to divide the plurality of sub pixels into a first area and a second area, and to apply the data voltage corresponding to a gray scale signal responsive to the first gray scale voltage to the first area and to apply the data voltage corresponding to a gray scale signal responsive to the second gray scale voltage to the second area.

According to an aspect of the present invention, sub pixels within a pixel belong to a same area, and each pixel along the first extensional direction belongs to a different area from an adjacent pixel.

According to an aspect of the present invention, sub pixels within a pixel belong to a same area, and each pixel along the second extensional direction belongs to a different area from an adjacent pixel.

According to an aspect of the present invention, sub pixels within a pixel belong to a same area, and at least a portion of each pixels is adjacent with both the first area and the second area along the second extensional direction.

According to an aspect of the present invention, a color arrangement of sub pixels within each pixel is different from a color arrangement of sub pixels within an adjacent pixel along the second extensional direction of the data line.

According to an aspect of the present invention, an aligning mode of the liquid crystal layer is a vertically aligned mode.

According to an aspect of the present invention, the thin film transistor substrate includes a pixel electrode layer having a pixel electrode incision pattern.

According to an aspect of the present invention, the liquid crystal display further includes a common electrode layer formed on the insulating substrate, the common electrode layer having a common electrode incision pattern.

The foregoing and/or other aspects of the present invention are also achieved by providing a driving method of a liquid crystal display, the liquid crystal display having a thin film transistor substrate provided with a gate line arranged in a first extensional direction and a data line arranged in a second extensional direction, an insulating substrate opposite the thin film transistor substrate, and a liquid crystal layer interposed between the thin film transistor substrate and the insulating substrate, the method including dividing a plurality of sub pixels, formed by crossing of the gate line and the data line, into a first area and a second area; and applying a data voltage corresponding to a gray scale signal responsive to a first gray scale voltage to the first area and applying a data voltage corresponding to a gray scale signal responsive to a second gray scale voltage to the second area.

According to an aspect of the present invention, an aligning mode of the liquid crystal layer is a vertically aligned mode.

According to an aspect of the present invention, the thin film transistor substrate comprises a pixel electrode layer having a pixel electrode incision pattern, and the insulating substrate includes a common electrode layer having a common electrode incision pattern.

The foregoing and/or other aspects of the present invention are also achieved by providing a liquid crystal display having a thin film transistor substrate including a gate line arranged in a first extensional direction and a data line arranged in a second extensional direction; an insulating substrate opposite the thin film transistor substrate; a liquid crystal layer interposed between the thin film transistor substrate and the insulating substrate; a gray scale voltage generating part generating a gray scale voltage; a data driving part receiving the gray scale voltage from the gray scale voltage generating part, and applying a data voltage to a plurality of sub pixels formed by crossing of the gate line and the data line; and a signal controlling part comprising a gray scale converting part dividing the plurality of sub pixels into a first area responsive to a first gray scale voltage and a second area responsive to a second gray scale voltage, and converting a gray scale signal from an exterior.

The foregoing and/or other aspects of the present invention are also achieved by providing a driving method of a liquid crystal display, the liquid crystal display including a thin film transistor substrate provided with a gate line arranged in a first extensional direction and a data line arranged in a second extensional direction, an insulating substrate opposite the thin film transistor substrate, and a liquid crystal layer interposed between the thin film transistor substrate and the insulating substrate, the method comprising dividing a plurality of sub pixels, formed by crossing of the gate line and the data line, into a first area and a second area; and converting a gray scale signal from an exterior corresponding to the first area to be responsive to a first gray scale voltage, and converting a gray scale signal from an exterior corresponding to the second area to be responsive to a second gray scale voltage.

The foregoing and/or other aspects of the present invention are also achieved by providing a liquid crystal display including a plurality of pixels, each pixel including sub pixels, the sub pixels divided into first areas responsive to a first gray scale voltage and second areas responsive to a second gray scale voltage, the first gray scale voltage differing from the second gray scale voltage, and sub pixels residing in the first areas alternating with sub pixels residing in the second areas.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a block diagram of an exemplary embodiment of an LCD according to the present invention;

FIG. 2 is a plan view schematically illustrating the LCD in FIG. 1;

FIG. 3 is a cross-sectional view of the LCD, taken along line III-III in FIG. 2;

FIG. 4 illustrates an arrangement of a first area and a second area of the LCD according to an exemplary embodiment of the present invention;

FIG. 5 is a graph illustrating visibility enhancement of the LCD;

FIGS. 6a through 6c respectively illustrate exemplary embodiments of an arrangement of the first area and the second area of an LCD according to the present invention; and

FIG. 7 is a block diagram of another exemplary embodiment of an LCD according to the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. In the drawings, the thickness of layers, films, and regions are exaggerated for clarity. It will be understood that when an element such as a layer, film, region, or substrate is referred to as being “on” another element, it can be directly on the other element or intervening elements may also be present.

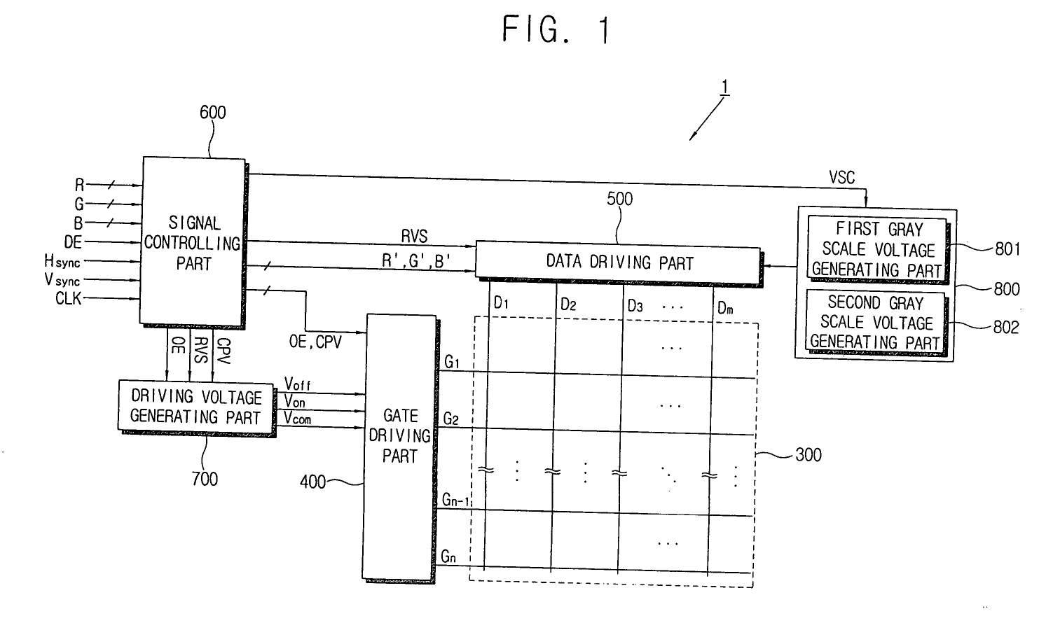

FIG. 1 is a block diagram of an exemplary embodiment of an LCD according to the present invention. As shown in FIG. 1, an LCD 1 includes a liquid crystal display panel 300, a gate driving part 400, and a data driving part 500, where the gate driving part 400 and the data driving part 500 are both connected to the liquid crystal display panel 300, a driving voltage generating part 700 connected to the gate driving part 400, a gray scale voltage generating part 800 connected to the data driving part 500, and a signal controlling part 600 controlling the gate driving part 400, data driving part 500, the driving voltage generating part 700, and the gray scale voltage generating part 800 by generating and supplying controlling signals.

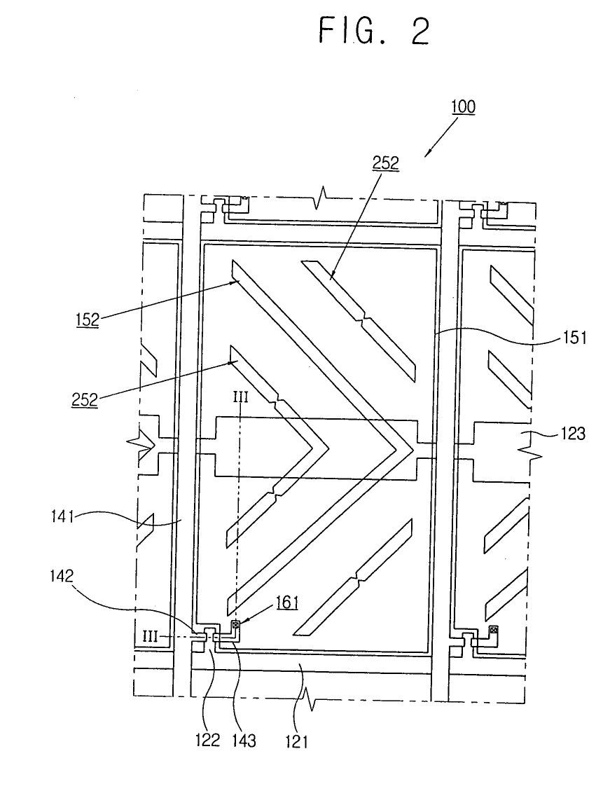

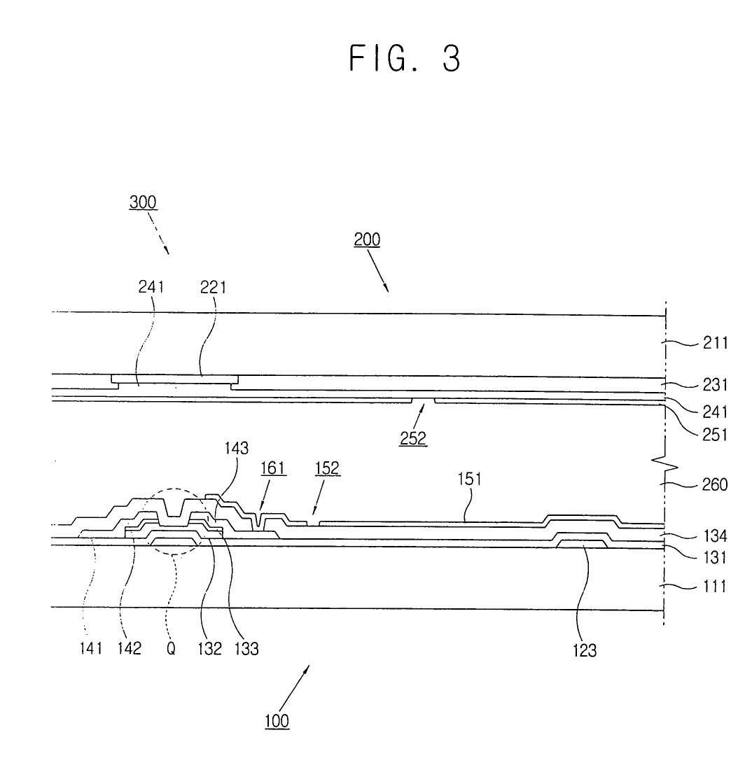

FIG. 2 is a plan view schematically illustrating the LCD 1, and FIG. 3 is a sectional view of the LCD 1, taken along line III-III in FIG. 2. As shown therein, the liquid crystal display panel 300 includes a TFT substrate 100, a color filter substrate 200 opposite the TFT substrate 100, and a liquid crystal layer 260 interposed there between.

The TFT substrate 100 comprises a gate line assembly 121, 122, and 123 on a first insulating substrate 111. The gate line assembly 121, 122, and 123 may be formed in a single layer or within multiple layers on the first insulating substrate 111. The gate line assembly 121, 122, and 123 comprises gate lines 121 extended transversely, a gate electrode 122 within each TFT, as shown in area Q, where the gate electrodes 122 are connected with the gate lines 121, and a common electrode line 123 forming storage capacity by interacting with a pixel electrode layer 151. There may be a plurality of gate lines 121 extending from the gate driving part 400, illustrated as Gl, G2, . . . , Gn-1, Gn in FIG. 1.

A gate insulating film 131, which may be made of, by example only, silicon nitride (“SiNx”), etc., covers the gate line assembly 121, 122, and 123 on the first insulating substrate 111.

On the gate insulating film 131 of the gate electrode 122 is formed a semiconductor layer 132 made of semiconductor material such as amorphous silicon or the like. On the semiconductor layer 132 is formed a resistance contact layer 133 made of silicide, n+hydrogenated amorphous silicon highly-doped with n-type impurities, or the like. The resistance contact layer 133 is divided into two portions by the gate electrode 122 in the area Q defining a TFT.

On the resistance contact layer 133 and the gate insulating film 131 is formed a data line assembly 141, 142, and 143. The data line assembly 141, 142, and 143 may also be formed in a single layer or multiple layers. The data line assembly 141, 142, and 143 includes a data line 141, a source electrode 142, and a drain electrode 143. The data lines 141 are formed in a vertical direction and cross the gate lines 121 to define pixels between a pair of adjacent data lines 141 and a pair of adjacent gate lines 121. There may be a plurality of data lines 141 extending from the data driving part 500, illustrated as D1, D1, D3, . . ., Dm in FIG. 1. The data lines 141 may extend in a direction that is substantially perpendicular to the gate lines 121, however the data lines 141 may be insulated from the gate lines 121. The source electrodes 142 branch from the data lines 141 and extend over the resistance contact layer 133. The drain electrodes 143 are separated from the source electrodes 142 and are formed over the resistance contact layer 133 while being opposite the source electrodes 142 across the gate electrodes 122, respectively.

A protective layer 134 is formed on both the data line assembly 141, 142, and 143 and a portion of the semiconductor layer 132 which is not covered with the data line assembly 141, 142, and 143, wherein the protective layer 134 is made of a SiNx layer, an a-Si:C:O layer or a-Si:O:F layer which are formed through plasma enhanced chemical vapor deposition (“PECVD”), an acryl-based organic insulating layer, etc. The protective layer 134 has a contact hole 161 through which the drain electrode 143 is exposed.

On the protective layer 134 is formed a pixel electrode layer 151. The pixel electrode layer 151 is generally made of a transparent conductive material such as indium tin oxide (“ITO”) or indium zinc oxide (“IZO”).

The pixel electrode layer 151 has a pixel electrode incision pattern 152 formed to divide the liquid crystal layer 260 into a plurality of domains with a common electrode incision pattern 252. The pixel electrode incision pattern 152 may include an incision intersecting the pixel electrode layer 151 in a generally angular direction with respect to a direction of the gate lines 121 and data lines 141. For example, the pixel electrode incision pattern 152 may include an incision extending angularly from a location generally corresponding to an intersection of a first gate line 121 and a first data line 141 to a location corresponding to the common electrode line 123 and a second adjacent data line 141, and then may further extend from the location corresponding to the common electrode line 123 and the second adjacent data line 141 angularly to a location generally corresponding to an intersection of the first data line 141 and an adjacent second gate line 121. While a particular pattern has been illustrated, alternate pixel electrode incision patterns 152 would also be within the scope of these embodiments.

On a second insulating substrate 211 of the color filter substrate 200 is formed a black matrix 221. Generally, the black matrix 221 partitions red, green, and blue filters, and excludes a direct light emitting to the TFT, as illustrated in the area Q, of the TFT substrate 100. The black matrix 221 is generally made of a photosensitive organic material added with a black pigment, such as carbon black, titanium oxide, etc.

On the color filter layer 231 are repeatedly positioned red, green, and blue filters divided by the black matrix 221. The color filter layer 231 endows a color to the light emitted from a back light unit (not shown) and transmitted through the liquid crystal layer 260. Generally, the color filter layer 231 is made of a photosensitive organic material.

An overcoat film 241 is formed on both the color filter layer 231 and the black matrix 221 not covered with the color filter layer 231. The overcoat film 241 flattens and protects the color filter layer 231, and is generally made of an acryl-based epoxy material. The overcoat film 241 is thus located generally between the color filter layer 231 and black matrix 221 and a common electrode layer 251, although the overcoat film 241 may be partially exposed to the liquid crystal layer 260 through a common electrode incision pattern 252 in the common electrode layer 251.

On the overcoat film 241 is formed the common electrode layer 251 made of a transparent conductive material such as ITO or IZO. The common electrode layer 251 applies a voltage directly to the liquid crystal layer 260 with the pixel electrode layer 151 of the TFT substrate 100. The common electrode layer 251 has the common electrode incision pattern 252. The common electrode incision pattern 252 divides the liquid crystal layer 260 into a plurality of domains with the pixel electrode incision pattern 152 of the pixel electrode layer 151. The common electrode incision pattern 252 may include an incision intersecting the common electrode layer 251 in a generally angular direction with respect to a direction of the gate lines 121 and data lines 141. For example, the common electrode incision pattern 252 may include a first incision having a V-shape smaller than a V-shape of the pixel electrode incision pattern 152, a second incision parallel to one side of the V-shape of the pixel electrode incision pattern 152, and a third incision parallel to the other side of the V-shape of the pixel electrode incision pattern 152. While the pixel electrode incision pattern 152 and the common electrode incision pattern 252 are spaced apart in a thickness direction by the liquid crystal layer 260, they are also spaced apart in a horizontal direction as shown by example in FIG. 2. That is, the common electrode incision pattern 252 and the pixel electrode incision pattern are formed adjacent different vertical cross-sectional sections of the liquid crystal layer 260, as illustrated in FIG. 3. While a particular pattern has been illustrated, alternate common electrode incision patterns 252 would also be within the scope of these embodiments.

Also, it should be understood that the pixel electrode incision pattern 152 and the common electrode incision pattern 252 may be formed in many arrangements, for example, the patterns 152, 252 may be formed in slant lines, may perpendicularly cross each other, etc. Thus, the incision patterns 152, 252 are not limited to the illustrated embodiments.

Between the TFT substrate 100 and the color filter substrate 200 is positioned the liquid crystal layer 260. In the vertically aligned (“VA”) mode, since a liquid crystal molecule of the liquid crystal layer 260 has a negative permittivity and anisotropy, a length direction thereof is vertical when the voltage is not applied. On the other hand, when the voltage is applied, the liquid crystal molecule is lain down vertically with respect to the direction of electric field. Without the pixel electrode incision pattern 152 and the common electrode incision pattern 252, the liquid crystal molecules are aligned out of order because the direction thereof cannot be determined, thereby forming a disclination line in a boundary surface in which aligned directions thereof are different. On the contrary, the pixel electrode incision pattern 152 and the common electrode incision pattern 252 make a fringe field and determine the aligned direction thereof when the voltage is applied. The liquid crystal layer 260 is divided into multiple areas according to the pattern of the pixel electrode incision pattern 152 and the common electrode incision pattern 252.

The driving voltage generating part 700 generates a gate on voltage (“Von”) turning on the TFT, as illustrated in area Q, a gate off voltage (“Voff”) turning off a switching element, and a common voltage (“Vcom”) applied to the pixel electrode layer 151. The voltages are applied via the gate driving part 400.

The gray scale voltage generating part 800 generates a plurality of gray scale voltages relating to the brightness of the LCD 1. The gray scale voltage generating part 800 comprises a first gray scale voltage generating part 801 generating a first gray scale voltage and a second gray scale voltage generating part 802 generating a second gray scale voltage, wherein the first gray scale voltage and the second gray scale voltage are different from each other. The first and second gray scale voltages are received by the data driving part 500. In one exemplary embodiment, the first gray scale voltage is higher than the second gray scale voltage.

The gate driving part 400, also termed a scan driver, is connected to the gate lines 121, e.g. G1, G2, Gn-1, Gn, and applies to each gate line 121 a gate signal that is made by mixing the gate on voltage Von and gate off voltage Voff from the driving voltage generating part 700.

The data driving part 500, also termed a source driver, receives the first gray scale voltage and the second gray scale voltage from the gray scale voltage generating part 800, and applies the first gray scale voltage or the second gray scale voltage, which is selected for each data line 141 (D1, D2, D3, . . ., Dm) by control of the signal controlling part 600, to the data line 141 respectively as a data signal.

The signal controlling part 600 generates a controlling signal that controls the gate driving part 400, the data driving part 500, the driving voltage generating part 700, and the gray scale voltage generating part 800, and supplies the controlling signal for the gate driving part 400, data driving part 500, and gray scale voltage generating part 800.

The operation of the LCD 1 is described as follows.

From an external graphic controller, the signal controlling part 600 receives an RGB gray scale signal (R, G, B) and an input control signal controlling the display thereof such as including one or more of a vertical synchronizing signal (“Vsync”), a horizontal synchronizing signal (“Hsync”), a main clock signal (“CLK”), a data enable signal (“DE”), etc. The signal controlling part 600 generates a gate control signal, a data control signal, and a voltage selection control signal (“VSC”), and modifies the RGB gray scale signal (R, G, B) pertinently according to an operating condition of the liquid crystal display panel 300, and thereafter supplies the gate control signal to the gate driving part 400 and the data driving part 500, the data control signal and the modified RGB gray scale signal (R′, G′, B′) to the data driving part 500, and the voltage selection control signal (“VSC”) to the gray scale voltage generating part 800.

The gate control signal comprises a vertical synchronization start signal (“STV”, not shown) ordering the output start of a gate on pulse (high portion of the gate signal), a gate clock signal (“CPV”) controlling the output period of the gate on pulse, a gate on enable signal (“OE”) defining the width of the gate on pulse, etc. The gate on enable signal OE and the gate clock signal CPV are supplied to the driving voltage generating part 700. The data control signal comprises a horizontal synchronization start signal (“STH”, not shown) ordering the input start of the gray scale signal, a load signal (“LOAD” or “TP”, not shown) ordering the application of a data voltage to the corresponding data line, a reverse control signal (“RVS”) reversing the polarity of the data voltage, a data clock signal (“HCLK”, not shown), etc.

Preferentially, the gray scale voltage generating part 800 supplies the gray scale voltage determined according to the voltage selection control signal VSC to the data driving part 500. The gray scale voltage generating part 800 includes the first gray scale voltage generating part 801 generating the first gray scale voltage and the second gray scale voltage generating part 802 generating the second gray scale voltage that, in one exemplary embodiment, is lower than the first gray scale voltage.

The gate driving part 400 applies the gate on voltage Von, according to the gate control signal from the signal controlling part 600, to each gate line 121 one by one, thereby turning on each respective TFT, as illustrated in area Q, connected thereto. At the same time, according to the data signal from the signal controlling part 600, the data driving part 500 supplies an analogue data voltage of the gray scale voltage generating part 800 that corresponds to the modified RGB gray scale signal (R′, G′, B′) for a pixel including a turned on switching element as a data signal to the corresponding data line 141. At that time, the signal controlling part 600 supplies to the data driving part 500 signals for each data line 141 supplied with the data voltage responsive to the first gray scale voltage or the second gray scale voltage, thereby, the gray scale voltage from the data driving part 500 to each data line 141 differs.

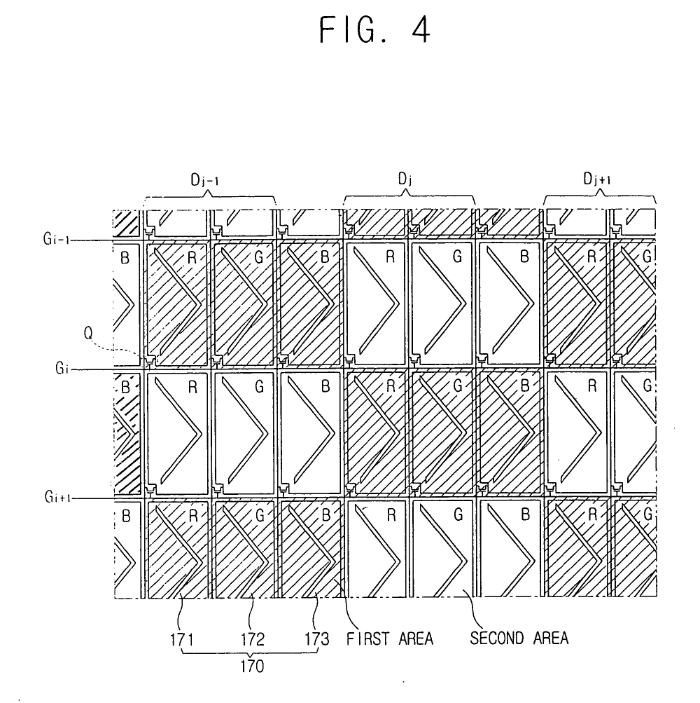

The data signal supplied to each data line 141 is applied to a corresponding pixel 170, such as illustrated in FIG. 4, through the turned on TFT. With this process, for one frame, as the gate on voltage Von is applied to all the gate lines 121 one by one, the data signal becomes applied to all pixels 170. When one frame is over and the reverse control signal RVS is supplied to the driving voltage generating part 700 and the data driving part 500, then the polarity of all the data signals for the next frame is changed.

In the next frame, the data line 141 responsive to the first gray scale voltage and/or the data line 141 responsive to the second gray scale voltage may be changed, which is also controlled by the signal controlling part 600.

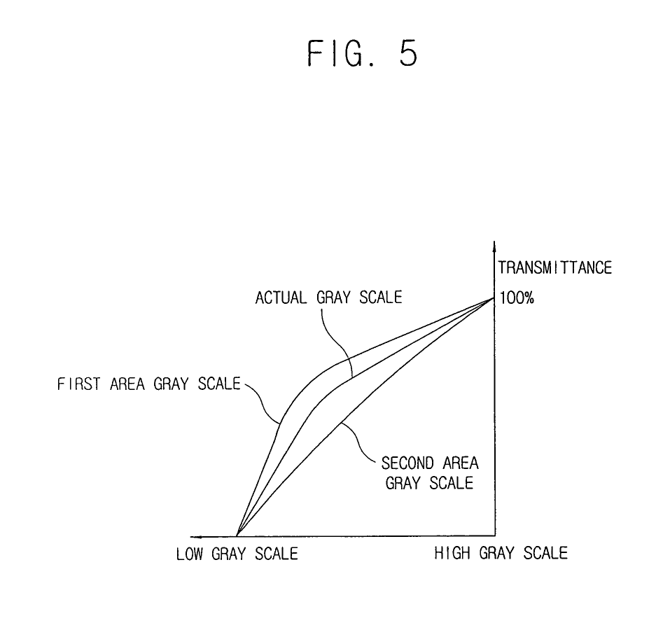

Herein below, the principle of visibility enhancement of the LCD 1 according to an exemplary embodiment of the present invention will be described with respect to FIG. 4 and FIG. 5.

FIG. 4 illustrates an exemplary embodiment of an arrangement of a first area and a second area of the LCD 1, and FIG. 5 is a graph illustrating visibility enhancement of the LCD 1.

Each pixel 170 comprises three sub pixels 171, 172, and 173 that have a red, green, and blue color filter layer 231 respectively, thereby comprising three data lines 141, where the data lines Dj−1, Dj, and Dj+1 are each representative of three adjacent data lines 141. Herein, the pixels 170 are divided into first areas (hatched portions, high gray scale areas) subject to the first gray scale voltage and second areas (low gray scale areas) subject to the second gray scale voltage. That is, the data voltage of the first gray scale voltage is.applied to the pixels 170 belonging to the first areas and the data voltage of the second gray scale voltage is applied to the pixels 170 belonging to the second areas.

In the first embodiment, the pixels 170 belonging to the first areas and the pixels 170 belonging to the second areas are not adjacent with each other. The pixels 170 adjacent along the extensional direction of a gate line 121 alternatingly belong to first and second areas and so do the pixels 170 adjacent along the extensional direction of a data line 141. In other words, in a direction corresponding to a longitudinal direction of a gate line 121, adjacent pixels 170 alternate between residing in a first area to residing in a second area, such that two adjacent pixels 170 do not both reside in the same area. Similarly, in a direction corresponding to a longitudinal direction of a data line 141, adjacent pixels 170 alternate between residing in a first area to residing in a second area, such that two adjacent pixels 170 do not both reside in the same area. For reference, the gate lines 121 are illustrated in FIG. 4 as Gi−1, Gi, and Gi+1.

As demonstrated by FIG. 5, with this configuration, the adjacent pixels 170 have different transmittance from each other according to the area, thereby visibility becomes enhanced. Specifically, visibility inferiority of middle gray scale may be enhanced without difficulty with the first gray scale voltage and the second gray scale voltage properly adjusted.

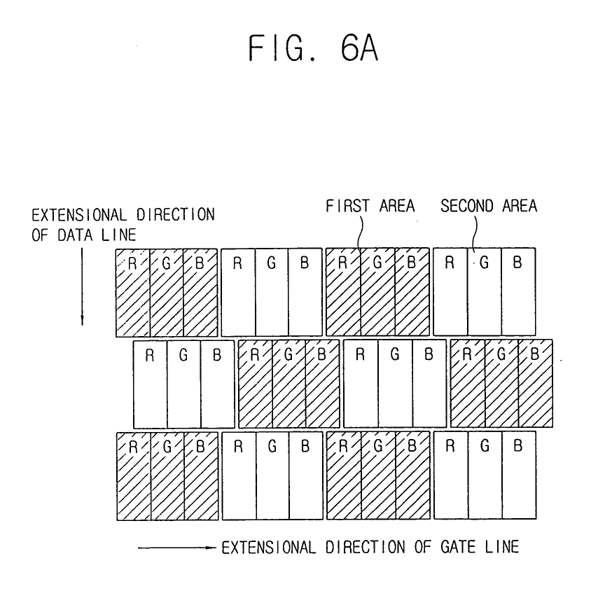

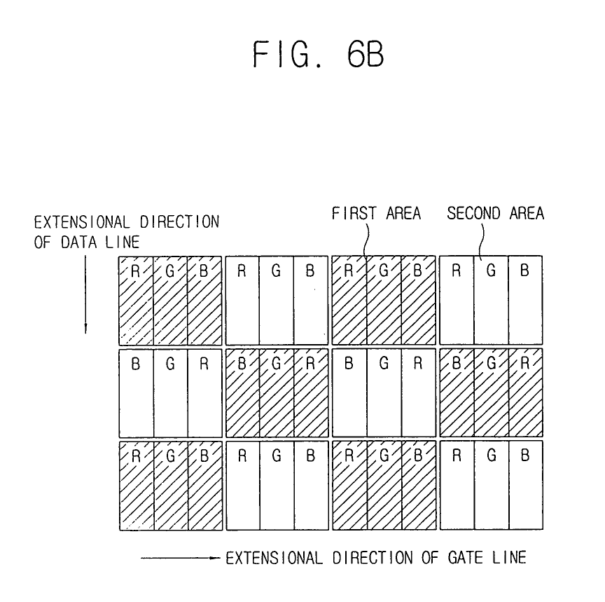

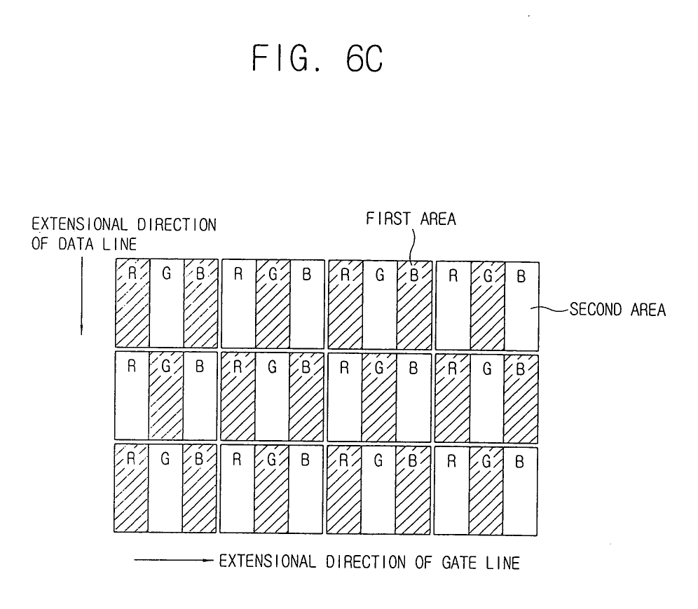

FIGS. 6A through 6C respectively illustrate more exemplary embodiments of an arrangement of the first area and the second area of an LCD according to the present invention.

As shown in FIG. 6A, each pixel adjacent along the extensional direction of the gate line 121 belongs to a different area, thereby, a different gray scale voltage is applied thereto. In this embodiment, each pixel along the extensional direction of the data line is adjacent to two pixels belonging to different areas. In other words, in a direction corresponding to a longitudinal direction of a gate line 121, adjacent pixels 170 alternate between residing in a first area to residing in a second area, such that two adjacent pixels 170 do not both reside in the same area. In a direction corresponding to a longitudinal direction of a data line 141, however, one pixel 170 will be adjacent in one direction to two separate pixels residing in the first and second areas, respectively, and will likewise be adjacent in an opposite direction to two separate pixels residing in the first and second areas, respectively. This occurs because the pixels arranged longitudinally in the direction of data line 141 are not arranged in precise columns, while the pixels arranged longitudinally in the direction of gate line 131 are arranged in rows that are shifted relative to adjacent rows. One exemplary application for the embodiment of FIG. 6A is a television in which the expression of image is more important than that of text. Of course, other applications of this embodiment are also within the scope of this invention.

In the embodiment shown in FIG. 6B, each pixel adjacent along the extensional direction of the gate line belongs to a different area. Also, each pixel is adjacent to a pixel belonging to a different and single area along the extensional direction of the data line. In other words, in a direction corresponding to a longitudinal direction of a gate line 121, adjacent pixels 170 alternate between residing in a first area to residing in a second area, such that two adjacent pixels 170 do not both reside in the same area. Similarly, in a direction corresponding to a longitudinal direction of a data line 141, adjacent pixels 170 alternate between residing in a first area to residing in a second area, such that two adjacent pixels 170 do not both reside in the same area. The difference between this embodiment and the embodiment in FIG. 4 is the arrangement of sub pixels within each pixel. The pixels are arranged so that the color arrangement of the sub pixels within the pixels adjacent along the extensional direction of the data line may be different from each other, i.e., adjacent pixels connected to different gate lines have different color arrangements of their respective sub pixels. For example, in a first column of pixels extending in a longitudinal direction of a data line, a first pixel may have a sub pixel arrangement of RGB, a second pixel may have a sub pixel arrangement of BGR, a third pixel may have a sub pixel arrangement of RGB (same as the first pixel), a fourth pixel may have a sub pixel arrangement of BGR (same as the second pixel), and so on, with every other pixel having a sub pixel arrangement of RGB, and every pixel in between having a sub pixel arrangement of BGR. Other patterns of sub pixel arrangements within the columns would also be within the scope of these embodiments. In the embodiment illustrated in FIG. 6B, each pixel in a first row extending in the longitudinal direction of a gate line has a sub pixel color arrangement of RGB, while each pixel in a second row adjacent to the first row has a sub pixel color arrangement of BGR, each pixel in a third row adjacent to the second row has a sub pixel arrangement of RGB (same as in the first row), each pixel in a fourth row adjacent to the third row has a sub pixel arrangement of BGR (same as in the second row), and so on. Other patterns of sub pixel arrangements within the rows would also be within the scope of these embodiments. Thus, the illustrated embodiment of FIG. 6B demonstrates alternating patterns of sub pixel arrangements of pixels within a column of pixels extending along a longitudinal direction of a data line. It would further be within the scope of these embodiments to alternate patterns of sub pixel arrangements within a row of pixels extending along a longitudinal direction of a gate line.

In the embodiment shown in FIG. 6C, each sub pixel of the same pixel belongs to a different area respectively. In other words, the sub pixels in a row of pixels extending in a longitudinal direction of a gate line alternate between residing in a first area subject to the first gray scale voltage and residing in a second area subject to the second gray scale voltage. In the illustrated embodiment, a first pixel in a first row includes a first sub pixel residing in a first area, a second sub pixel residing in a second area, and a third sub pixel residing in the first area. A second pixel adjacent to the first pixel in the first row includes a first sub pixel residing in the second area, a second sub pixel residing in the first area, and a third sub pixel residing in the second area. In a column of pixels arranged in a longitudinal direction of a data line, a first pixel may include a first sub pixel residing in the first area, a second pixel may include a first sub pixel residing in the second area, and a third pixel may include a first sub pixel residing in the first area. Likewise, the first pixel may include a second sub pixel residing in the second area, the second pixel may include a second sub pixel residing in the first area, and the third pixel may include a second sub pixel residing in the second area, and so on. In the illustrated embodiment of FIG. 6C, the sub pixels arranged in alternating first and second areas include continuous RGB sub pixel arrangements, however, alternative sub pixel arrangements, such as, but not limited to, the alternative sub pixel arrangements demonstrated in FIG. 6B, would also be within the scope of these embodiments.

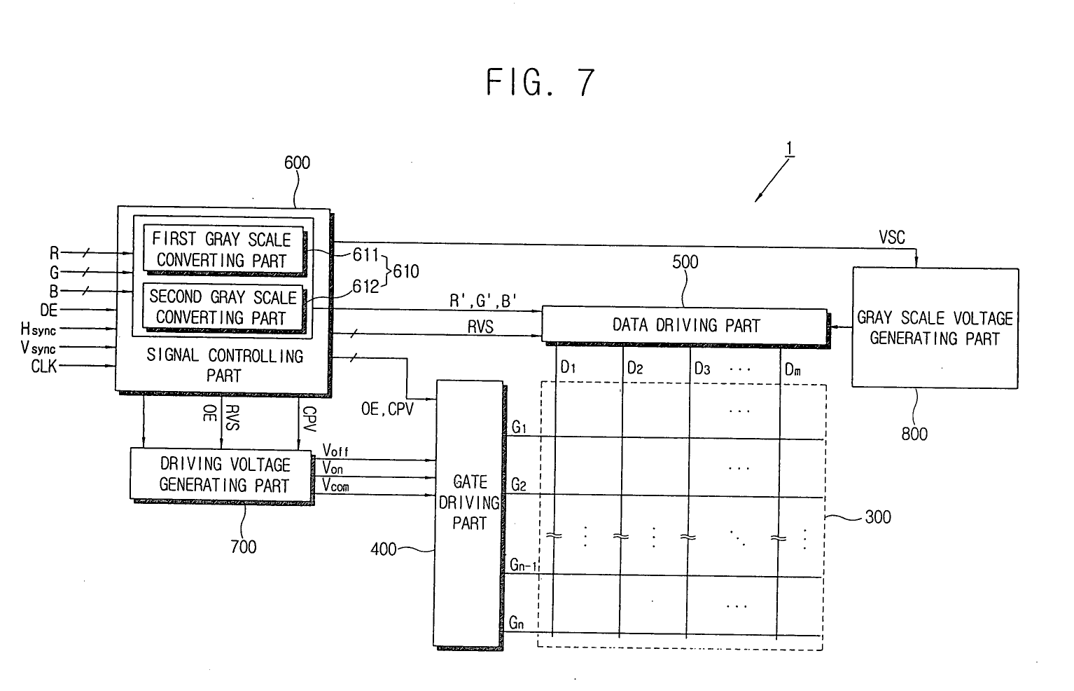

FIG. 7 is a block diagram of another exemplary embodiment of an LCD according to the present invention. As shown in FIG. 7, the signal controlling part 600 is provided with a gray scale converting part 610 processing the received gray scale signal (R, G, B) from the exterior. The gray scale converting part 610 comprises a first gray scale converting part 611 and a second gray scale converting part 612.

The gray scale voltage generating part 800 generates a single gray scale voltage.

The sub pixels of the liquid crystal display panel 300 are divided into the first area and the second area. The first gray scale converting part 611 converts the gray scale signal (R, G, B) corresponding to the first area, thereby, to be responsive to the first gray scale voltage, and the second gray scale converting part 612 converts the gray scale signal (R, G, B) corresponding to the second area, thereby to be responsive to the second gray scale voltage.

The converted gray scale signal (R′, G′, B′) from the gray scale converting part 610 is input to the data driving part 500, and the data voltage corresponding thereto is applied to the liquid crystal display panel 300. The gray scale voltage generating part 800 supplies the single gray scale voltage to the data driving part 500. Since the gray scale converting part 610 divides the sub pixels into the first area and the second area, and allows the gray scale voltage applied to the first area and the second area respectively to be different, the transmittance between the first area and the second area becomes different.

The arrangement of the pixels and their respective sub pixels according to the first embodiment through the fourth embodiment may be applied to that of the pixels and sub pixels according to the fifth embodiment. That is, the LCD panel 300 of FIG. 7 may incorporate a pixel and sub pixel arrangement as shown and taught by any of the embodiments described with respect to FIGS. 4, 6A, 6B, and 6C.

According to the present invention, since the transmittance by the pixel or the sub pixel is different with visibility enhancement, unlike in the case of realizing different transmittance in one sub pixel, aperture ratio is not deteriorated and additional wiring is not needed. Moreover, since different transmittance is realized by the arrangements of the pixels, there is no problem of flicker phenomenon occurring or the pattern of the area is recognized to a user, unlike in the case of differing the transmittance of the pixel according to the time (frame).

Although a few embodiments of the present invention have been shown and described, it will be appreciated by those skilled in the art that changes may be made in these embodiments without departing from the principles and spirit of the invention, the scope of which is defined in the appended claims and their equivalents. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A liquid crystal display comprising:
a thin film transistor substrate formed with a gate line arranged in a first extensional direction and a data line arranged in a second extensional direction;
an insulating substrate opposite the thin film transistor substrate;
a liquid crystal layer interposed between the thin film transistor substrate and the insulating substrate;
a gray scale voltage generating part comprising a first gray scale voltage generating part generating a first gray scale voltage, and a second gray scale voltage generating part generating a second gray scale voltage;
a data driving part receiving the first and second gray scale voltages from the gray scale voltage generating part, and applying a data voltage to a plurality of sub pixels formed by crossing of the gate line and the data line; and
a signal controlling part controlling the data driving part to divide the plurality of sub pixels into a first area and a second area, and to apply the data voltage corresponding to a gray scale signal responsive to the first gray scale voltage to the first area and to apply the data voltage corresponding to a gray scale signal responsive to the second gray scale voltage to the second area.

2. The liquid crystal display according to claim 1, wherein sub pixels within a pixel belong to a same area, and each pixel along the first extensional direction belongs to a different area from an adjacent pixel.

3. The liquid crystal display according to claim 1, wherein sub pixels within a pixel belong to a same area, and each pixel along the second extensional direction belongs to a different area from an adjacent pixel.

4. The liquid crystal display according to claim 1, wherein sub pixels within a pixel belong to a same area, and at least a portion of each pixel is adjacent with both the first area and the second area along the second extensional direction.

5. The liquid crystal display according to claim 1, wherein a color arrangement of sub pixels within a pixel is different from a color arrangement of sub pixels within an adjacent pixel along the second extensional direction.

6. The liquid crystal display according to claim 1, wherein an aligning mode of the liquid crystal layer is a vertically aligned mode.

7. The liquid crystal display according to claim 1, wherein the thin film transistor substrate comprises a pixel electrode layer having a pixel electrode incision pattern.

8. The liquid crystal display according to claim 1, further comprising a common electrode layer formed on the insulating substrate, the common electrode layer having a common electrode incision pattern.

9. A driving method of a liquid crystal display, the liquid crystal display comprising a thin film transistor substrate provided with a gate line extending in a first extensional direction and a data line extending in a second extensional direction, an insulating substrate opposite the thin film transistor substrate, and a liquid crystal layer interposed between the thin film transistor substrate and the insulating substrate, the method comprising:
dividing a plurality of sub pixels, formed by crossing of the gate line and the data line, into a first area and a second area; and
applying a data voltage corresponding to a gray scale signal responsive to a first gray scale voltage to the first area and applying a data voltage corresponding to a gray scale signal responsive to a second gray scale voltage to the second area.

10. The driving method of claim 9, wherein an aligning mode of the liquid crystal layer is a vertically aligned mode.

11. The driving method of claim 9, wherein the thin film transistor substrate comprises a pixel electrode layer having a pixel electrode incision pattern, and the insulating substrate comprises a common electrode layer having a common electrode incision pattern.

12. A liquid crystal display comprising:
a thin film transistor substrate comprising a gate line arranged in a first extensional direction and a data line arranged in a second extensional direction;
an insulating substrate opposite the thin film transistor substrate;
a liquid crystal layer interposed between the thin film transistor substrate and the insulating substrate;
a gray scale voltage generating part generating a gray scale voltage;
a data driving part receiving the gray scale voltage from the gray scale voltage generating part, and applying a data voltage to a plurality of sub pixels formed by crossing of the gate line and the data line; and
a signal controlling part comprising a gray scale converting part dividing the plurality of sub pixels into a first area responsive to a first gray scale voltage and a second area responsive to a second gray scale voltage, and converting a gray scale signal from an exterior.

13. The liquid crystal display according to claim 12, including a first gray scale converting part and a second gray scale converting part in the gray scale converting part, the first gray scale converting part converting the gray scale signal corresponding to the first area to be responsive to the first gray scale voltage, and the second gray scale converting part converting the gray scale signal corresponding to the second area to be responsive to the second gray scale voltage.

14. The liquid crystal display according to claim 12, having sub pixels within a pixel belonging to a same area, and each pixel along the first extensional direction belongs to a different area from an adjacent pixel.

15. The liquid crystal display according to claim 12, having sub pixels within a pixel belonging to a same area, and each pixel along the second extensional direction belongs to a different area from an adjacent pixel.

16. The liquid crystal display according to claim 12, having sub pixels within a pixel belonging to a same area, and at least a portion of each pixel is adjacent with both the first area and the second area along the second extensional direction.

17. The liquid crystal display according to claim 12, having a color arrangement of sub pixels within a pixel different from a color arrangement of sub pixels within an adjacent pixel along the second extensional direction.

18. A driving method of a liquid crystal display, the liquid crystal display comprising a thin film transistor substrate provided with a gate line arranged in a first extensional direction and a data line arranged in a second extensional direction, an insulating substrate opposite the thin film transistor substrate, and a liquid crystal layer interposed between the thin film transistor substrate and the insulating substrate, the method comprising:
dividing a plurality of sub pixels, formed by crossing of the gate line and the data line, into a first area and a second area; and
converting a gray scale signal from an exterior corresponding to the first area to be responsive to a first gray scale voltage, and converting a gray scale signal from an exterior corresponding to the second area to be responsive to a second gray scale voltage.

19. A liquid crystal display comprising:
a plurality of pixels, each pixel including sub pixels, the sub pixels divided into first areas responsive to a first gray scale voltage and second areas responsive to a second gray scale voltage, the first gray scale voltage differing from the second gray scale voltage, and sub pixels residing in the first areas alternating with sub pixels residing in the second areas.

20. The liquid crystal display of claim 19, further comprising a gray scale voltage generating part generating the first gray scale voltage and the second gray scale voltage.

21. The liquid crystal display of claim 19, further comprising a signal controlling part having a gray scale converting part dividing the sub pixels into the first areas responsive to the first gray scale voltage and the second areas responsive to the second gray scale voltage, the signal controlling part converting a gray scale signal from an exterior.
